(19) United States
(12) Patent Application Publication
(10) Pub. No.: US 2019/0016564 A1
(43) Pub. Date: Jan. 17, 2019

(54) ELEVATOR AMBIANCE VARIATOR

(71) Applicant: OTIS Elevator Company, Farmington, CT (US)

(72) Inventor: Romain Fragner, Sandillon (FR)

(21) Appl. No.: 16/031,707

(22) Filed: Jul. 10, 2018

(30) Foreign Application Priority Data
Jul. 11, 2017 (EP) 17305903.1

(51) Int. Cl. B66B 11/02; B66B 1/14

(52) U.S. Cl. CPC B66B 11/0233; B66B 1/14

(57) ABSTRACT

An elevator car control panel is provided. The elevator car control panel includes buttons by which one or more passengers of the elevator car control ascension and declension of the elevator car, an opening and closing of doors of the elevator car, an alarm and contact with an administrator and a variator by which one or more passengers control an elevator car atmospheric condition.

### CROSS-REFERENCE TO RELATED APPLICATIONS

This application claims the benefit of European Patent Application No. 17305903.1, filed Jul. 11, 2017, which is incorporated herein by reference in its entirety.

### BACKGROUND

The following description relates to elevators and, more specifically, to elevator ambiance variators.

An elevator permits a passenger to board an elevator car at a boarding floor, to safely ride the elevator car to a different floor and to dismount from the elevator car at the different floor. An elevator system may include multiple elevator cars servicing multiple floors and a controller that responds to elevator calls at any one of those floors by dispatching an elevator car thereto.

Once a passenger boards an elevator car, the elevator car doors close as the elevator car ascends or descends to a selected floor. During the ascension or declension, besides any human activity, the atmosphere within the elevator car can be quiet or filled with noise sometimes derided as “elevator music” while the lighting scheme is essentially pre-defined by the lighting fixtures that are already pre-installed within the elevator car. The action of the elevator car is similarly pre-defined by the configuration and power of the elevator car motor which drives the ascension and declension.

### BRIEF DESCRIPTION

According to an aspect of the disclosure, an elevator car control panel is provided. The elevator car control panel includes buttons by which one or more passengers of the elevator car control ascension and declension of the elevator car, an opening and closing of doors of the elevator car, an alarm and contact with an administrator and a variator by which one or more passengers control an elevator car atmospheric condition.

In accordance with additional or alternative embodiments, a touchscreen is provided on which at least one of the buttons and the variator is displayed.

In accordance with additional or alternative embodiments, the variator includes an analog guide and an analog boss slidably movable relative to the analog guide by the one or more of the passengers to execute the control of the elevator car atmospheric condition.

In accordance with additional or alternative embodiments, the variator includes a graphical guide and a graphical boss slidably movable relative to the graphical guide by the one or more of the passengers to execute the control of the elevator car atmospheric condition.

In accordance with additional or alternative embodiments, the elevator car atmospheric condition includes at least one of an interior lighting level, a lighting color, an interior musical choice, a speed of the ascension and declension and a priority parameter.

In accordance with additional or alternative embodiments, the variator is provided as one or more of first through fifth variators, the first variator being arrayed on the control panel by which one or more of the passengers controls the elevator car atmospheric condition through control of an interior lighting level, the second variator being arrayed on the control panel by which one or more of the passengers controls the elevator car atmospheric condition through control of an interior lighting color, the third variator being arrayed on the control panel by which one or more of the passengers controls the elevator car atmospheric condition through control of an interior musical choice, the fourth variator being arrayed on the control panel by which one or more of the passengers controls the elevator car atmospheric condition through control of a speed of the ascension and declension and the fifth variator being arrayed on the control panel by which one or more of the passengers controls the elevator car atmospheric condition through control of a priority parameter.

According to another aspect of the disclosure, an elevator car is provided and includes an elevator car control panel as described above and an elevator body.

In accordance with additional or alternative embodiments, the elevator car control panel is supportively disposed on the elevator body.

In accordance with additional or alternative embodiments, the elevator body is formed to define an interior for accommodating the one or more passengers.

In accordance with additional or alternative embodiments, doors open and close to permit ingress and egress relative to the interior.

In accordance with additional or alternative embodiments, an atmospheric feature is responsive to the control of the elevator car atmospheric condition.

In accordance with additional or alternative embodiments, a controller configured to customize the elevator car atmospheric condition.

In accordance with additional or alternative embodiments, the controller is communicative with a portable computing device and customizes the elevator car atmospheric condition based on information derived from portable device communication.

According to yet another aspect of the disclosure, an elevator system is provided and includes an elevator car as described above, a hoistway in which the elevator car is movably disposed and a machine configured to drive ascension and declension of the elevator car within the hoistway.

In accordance with additional or alternative embodiments, the elevator car and the hoistway are provided as respective multiples thereof

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of an elevator system in accordance with embodiments;

FIG. 2 is a perspective view of an elevator car of the elevator system of FIG. 1 in accordance with embodiments;

FIG. 3 is a plan view of a control panel of an elevator car in accordance with embodiments;

FIG. 4 is a schematic illustration of a variator of the control panel of FIG. 3 in accordance with embodiments;

FIG. 5 is a schematic illustration of a variator of the control panel of FIG. 3 in accordance with alternative embodiments; and

FIG. 6 is a schematic diagram of a controller of an elevator car in accordance with embodiments.

### DETAILED DESCRIPTION

As will be described below, a variator is provided for use in a control panel of an elevator car so that a passenger can change a color inside the elevator car from cold white to warm yellow, for example, and/or change the intensity or brightness of the light in order for them to have an improved passenger experience. The interface can be integrated in the aesthetics of the elevator car (e.g., as a touch screen or a button integrated in the control panel) making it simple and attractive to the passenger. The changes made by the passenger can be saved in an application so that the ambiance can be changed in the elevator before the passenger enters for a next ride.

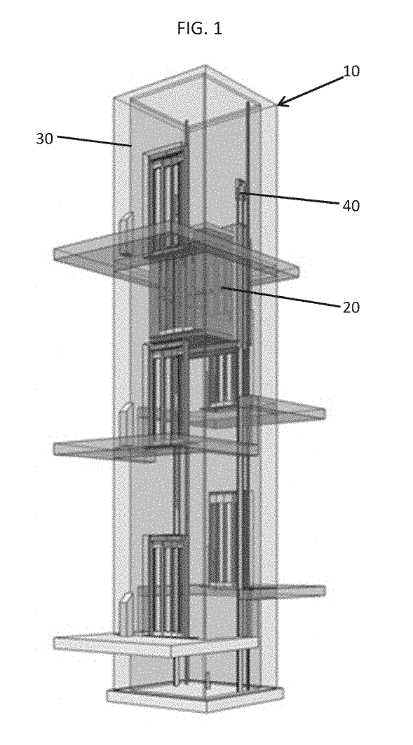

With reference to FIG. 1, an elevator system 10 is provided. The elevator system 10 includes an elevator car 20, a hoistway 30 in which the elevator car 20 is movably disposed and a machine 40 that is configured to drive ascension and declension of the elevator car 20 within the hoistway 30. The hoistway 30 may be defined in a building with multiple floors and may be provided as multiple hoistways 30 that respectively serve some or all of the multiple floors. The elevator car 20 may similarly be provided as multiple elevator cars 20 that are respectively disposed in corresponding ones of the multiple hoistways 30. Moreover, the machine 40 may be provided as multiple machines 40 that are respectively configured to drive the ascension and declension of each corresponding one of the multiple elevator cars 20 within the corresponding ones of the multiple hoistways 30. In addition, the multiple hoistways 30 may be clustered together within the building with access being provided to passengers by way of elevator bays proximate to the multiple hoistways 30 which are each served by at least some or all of the elevator cars 20.

For purposes of clarity and brevity, the following description will relate to the embodiments in which only a single elevator car 20 is provided. It is to be understood, however, that this is not intended to limit the scope of the application in any way and that other embodiments are possible.

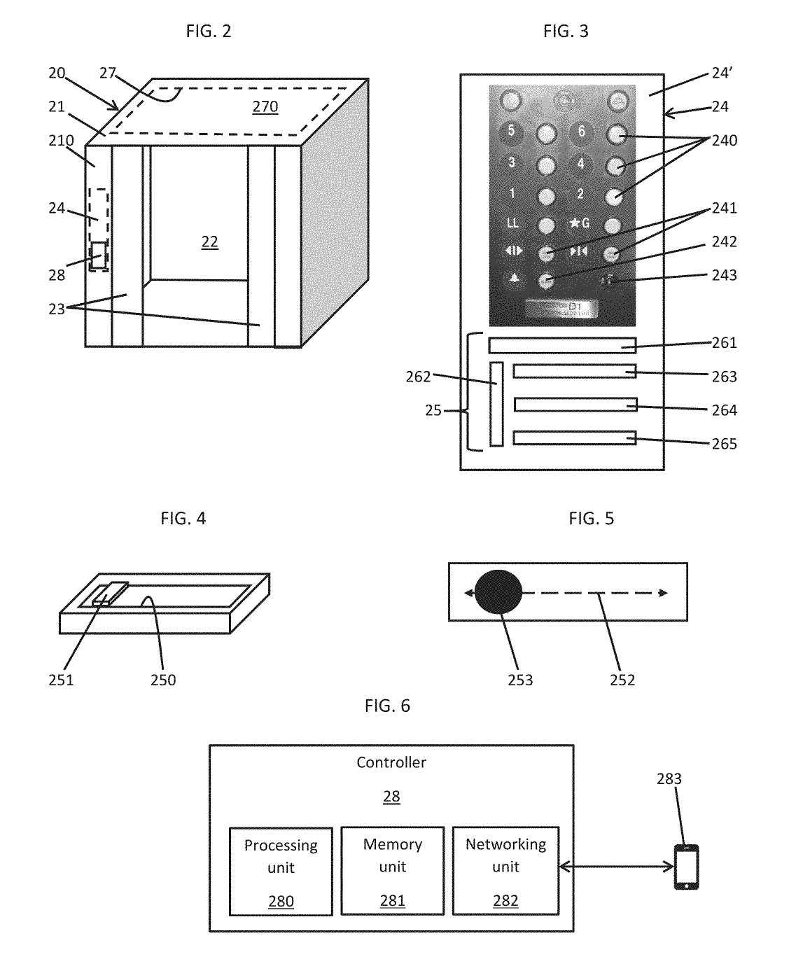

With reference to FIG. 2, the elevator car 20 includes a body 21 that is formed to define an interior 22 for accommodating passengers, doors 23 that open and close to permit ingress and egress relative to the interior 22 and a control panel 24 that is supportively disposed on a sidewall 210 of the body 21.

With reference to FIGS. 3-5, the control panel 24 may be provided as an analog or touchscreen panel 24′. In either case, the control panel 24 includes first buttons 240 that are arrayed on the control panel 24 and which are actuatable by one or more of the passengers to control the ascension and declension of the elevator car 20 (e.g., floor buttons), second buttons 241 that are arrayed on the control panel 24 and which are actuatable by one or more of the passengers to control an opening and closing of the doors 23 (e.g., door open and door close buttons), third buttons 242 that are arrayed on the control panel 24 and which are actuatable by one or more of the passengers to control an alarm (e.g., stop and alarm buttons) and fourth buttons 243 that are arrayed on the control panel 24 and which are actuatable by one or more of the passengers to control a communications device to engage contact with an external administrator (e.g., phone call buttons).

The control panel 24 further includes at least one or more variators 25. The at least one or more variators 25 are arrayed on the control panel 24 and are actuatable by one or more of the passengers to control an atmospheric condition within the interior or an operation of the machine. As shown in FIG. 4, the at least one or more variators 25 may include an analog guide 250 and an analog boss 251 that is slidably movable relative to the analog guide 250 by the one or more of the passengers to execute the control of the atmospheric condition. As shown in FIG. 5, the at least one or more of the variators 25 may include a graphical guide 252 and a graphical boss 253 that is graphically movable relative to the graphical guide 252 by the one or more passengers to execute the control of the atmospheric condition.

As shown in FIG. 3, the at least one or more variators 25 may include at least one or more of a first variator 261, a second variator 262, a third variator 263, a fourth variator 264 and a fifth variator 265. The first variator 261 is a light level variator and is actuatable by one or more of the passengers to control a lighting level in the interior 22. The second variator 262 is a light color variator and is actuatable by one or more of the passengers to control a lighting color in the interior 22. The third variator 263 is a musical variator and is actuatable by one or more passengers to control a musical, audio or visual choice and/or a musical, audio or video volume in the interior 22. The fourth variator 264 is a speed variator and is actuatable by one or more passengers to control a speed of the ascension and declension of the elevator car 20 in which the actuating passenger stands. The fifth variator 265 is a priority variator and is actuatable by one or more passengers to control a signaled request for higher or lower priority for the associated elevator car 20 (e.g., such that the elevator car 20 in which a passenger actuates the fourth variator 264 can proceed to a certain floor without delay).

With reference back to FIG. 2, the elevator car 20 may further include an atmospheric feature 27 and a controller 28.

The atmospheric feature 27 is responsive to the control of the atmospheric condition executed by the one or more passengers by way of one or more of the first-fifth variators 261-265. In an exemplary case, the atmospheric feature 27 may include a lighting fixture 270 which is controllable by way of the first variator 261 to increase or decrease an amount of light emitted thereby or by way of the second variator 262 to change a color of the light emitted thereby. That is, a passenger who wants to ride the elevator car 20 in a relaxing state may use the first and second variators 261 and 262 to lower a light level in the interior 22 and to darken the color of the light emitted into the interior 22 by the lighting fixture 270.

With reference to FIG. 6, the controller 28 may be provided as a computing device and may include a processing unit 280, a memory unit 281 and a networking unit 282 by which the processing unit 280 is communicative with external devices such as, for example, a passenger's portable computing or electronic device (e.g., smartphone, tablet or laptop) 283. The memory unit 281 has executable instructions stored thereon which, when executed, cause the processing unit 280 to operate as described herein (e.g., to respond to certain actuations of the control panel 24 by the one or more passengers, to operate the elevator system 10 or the elevator car 20, to communicate with the passenger's portable computing or electronic device 283, etc.). In accordance with embodiments, in those cases in which the processing unit 280 of the controller 28 communicates with the passenger's portable computing or electronic device 283, the processing unit 280 of the controller 28 may operate by customizing one or more atmospheric conditions in the interior 22 based on personal information derived from the communication. That is, if the passenger is listening to a song on his smartphone, the controller 28 could play that song on the speaker of the elevator car. In addition, if the passenger has previously selected a certain color and lighting brightness in the elevator car 20 by way of the first and second variators 261 and 262, the controller 28 could automatically set those characteristics when the passenger re-boards.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An elevator car control panel, the elevator car control panel comprising:
buttons by which one or more passengers of the elevator car control ascension and declension of the elevator car, an opening and closing of doors of the elevator car, an alarm and contact with an administrator; and
a variator by which one or more passengers control an elevator car atmospheric condition.

2. The elevator car control panel according to claim 1, further comprising a touchscreen on which at least one of the buttons and the variator is displayed.

3. The elevator car control panel according to claim 1, wherein the variator comprises:
an analog guide; and
an analog boss slidably movable relative to the analog guide by the one or more of the passengers to execute the control of the elevator car atmospheric condition.

4. The elevator car control panel according to claim 1, wherein the variator comprises:
a graphical guide; and
a graphical boss slidably movable relative to the graphical guide by the one or more of the passengers to execute the control of the elevator car atmospheric condition.

5. The elevator car control panel according to claim 1, wherein the elevator car atmospheric condition comprises at least one of an interior lighting level, a lighting color, an interior musical choice, a speed of the ascension and declension and a priority parameter.

6. The elevator car control panel according to claim 1, wherein the variator is provided as one or more of first through fifth variators,
the first variator being arrayed on the control panel by which one or more of the passengers controls the elevator car atmospheric condition through control of an interior lighting level,
the second variator being arrayed on the control panel by which one or more of the passengers controls the elevator car atmospheric condition through control of an interior lighting color,
the third variator being arrayed on the control panel by which one or more of the passengers controls the elevator car atmospheric condition through control of an interior musical choice,
the fourth variator being arrayed on the control panel by which one or more of the passengers controls the elevator car atmospheric condition through control of a speed of the ascension and declension, and
the fifth variator being arrayed on the control panel by which one or more of the passengers controls the elevator car atmospheric condition through control of a priority parameter.

7. An elevator car, comprising:
an elevator car control panel as claimed in claim 1; and
an elevator body.

8. The elevator car according to claim 7, wherein the elevator car control panel is supportively disposed on the elevator body.

9. The elevator car according to claim 7, wherein the elevator body is formed to define an interior for accommodating the one or more passengers.

10. The elevator car according to claim 9, further comprising doors that open and close to permit ingress and egress relative to the interior.

11. The elevator car according to claim 7, further comprising an atmospheric feature which is responsive to the control of the elevator car atmospheric condition.

12. The elevator car according to claim 7, further comprising a controller configured to customize the elevator car atmospheric condition.

13. The elevator car according to claim 12, wherein the controller is communicative with a portable computing device and customizes the elevator car atmospheric condition based on information derived from portable device communication.

14. An elevator system, comprising:
an elevator car according to claim 7;
a hoistway in which the elevator car is movably disposed; and
a machine configured to drive ascension and declension of the elevator car within the hoistway.

15. The elevator system according to claim 14, wherein the elevator car and the hoistway are provided as respective multiples thereof
